(19) United States
(12) Patent Application Publication
(10) Pub. No.: US 2020/0042909 A1
(43) Pub. Date: Feb. 6, 2020

(54) METHOD AND APPARATUS FOR RECORDING, PROCESSING, VISUALISATION AND APPLICATION OF AGRONOMICAL DATA

(71) Applicant: GAMAYA SA, Lausanne (CH)

(72) Inventors: Yosef AKHTMAN, St-Prex (CH); Ellen CZAIKA, Horgen (CH)

(21) Appl. No.: 16/479,805

(22) PCT Filed: Jan. 24, 2018
(86) PCT No.: PCT/IB2018/050427

§ 371 Date: Jul. 22, 2019

(30) Foreign Application Priority Data
Jan. 24, 2017 (IB) PCT/IB2017/050360

(51) Int. Cl. G06Q 10/06; G06Q 50/02; G06Q 10/04; G06N 20/00; G06N 3/08; A01B 79/00

(52) U.S. Cl. CPC G06Q 10/06; G06Q 50/02; A01B 79/005; G06N 20/00; G06N 3/08; G06Q 10/04

(57) ABSTRACT

The present disclosure relates to methods and devices for a systemic approach to plant-based ecosystem management, including for juxtaposing, processing, organising, and visualizing data relevant to plant-based ecosystems, such as agricultural ecosystems, and delineating external interventions into such systems, such as human interventions, including those with automated machines. Recognizing the time-based—for example, seasonal—nature of plant-based ecosystems, this invention) juxtaposes relevant—but often previously dispersed—data types, 2) organizes them in tensors of customizable dimensions so as to facilitate modeling and in particular deep neural network and other deep machine learning and artificial intelligence approaches that take into account time-based, or other variable-based, changes to identify areas of interest within given land parcels, and 3) visualizes the data so as to highlight time-based, or other variable-based, relationships and trends. Such steps facilitate the development of individual plant or sub-land-parcel prescriptions for human intervention aimed at optimizing ecosystem output traits in the current season while considering their impact on subsequent seasons, thereby enabling the systematic management of plant-based ecosystems.

### TECHNICAL FIELD

The invention relates to the fields of agronomy, agriculture—including precision agriculture, and ecosystem management.

### BACKGROUND OF THE INVENTION

Precision—also called spatially-variable, prescription etc.—agriculture or farming has been in use for over two decades. It is often thought of as the «observation, impact assessment and timely strategic response to fine-scale variation in causative components of an agricultural production process» (Precision Agriculture Laboratory, 2016; Drysdale and Metternicht, 2003). Applying precision agriculture to plant-based settings such as the production of crops, is sometimes classified as a subset of precision agriculture called site-specific management, which is defined as “matching resource application and agronomic practices with soil and crop requirements as they vary in space and time within a field” (Whelan and McBratney, 2000). Patents exist describing systems and/or methods that enable the spreading of precise amounts of agricultural inputs onto specific parts of a field (e.g., U.S. Pat. No. 6,554,299) and geopositioning within fields (e.g., WO 2016/191893 A1). A number of prior art systems and/or methods focus on different types of crops or plants—for example, U.S. Pat. No. 6,336,066 describes a means for applying precise amounts of agricultural inputs to perennial crops like grapes.

However, before being able to apply precise amounts to specific locations, prescriptions for the amount per location must be determined, as some authors have recognized. Patent publications such as CN 105787801 A to Mathur et al., U.S. Pat. No. 7,343,867 to Fraisse et al., US 2009/0,007,485 to Holland, U.S. Pat. No. 6,058,351 to McCauley, WO 2016123201 to Kumar et al., and U.S. Pat. No. 6,236,907 B1 to Hauwiller and Jin focus on decision support and the determination of specific agricultural actions.

The U.S. Pat. No. 6,236,907 patent publication for recommending the amounts of agrichemicals to apply to specific areas of a field focuses on compact storage of the data—using a field spatial database—that enables extraction of the data in useful formats. It fails to organise the data around date or take a seasonal view, or to specifically organise the data to facilitate machine learning algorithms, including those used for creating sub-field areas.

Patent publications US 2009/0,007,485 and WO 2016123201 propose approaches involving remote sensing. Patent publication US 2009/0,007,485 outlines a method that frees practitioners from the need for a reference field; international publication WO 2016123201 relies on three dimensional (3D) imagery. Furthermore, U.S. Pat. No. 6,058,351 proposes an approach using a specific artificial intelligence algorithm.

Regarding a circular representation of juxtaposed data types, a setup for displaying musical scores by instrument offers a similar approach in a different technical field, as described in patent publication US patent 2008/0245,212.

### SUMMARY OF INVENTION

In a first aspect, the invention provides a method for creating a plant-based ecosystem for at least a parcel of land. The method comprises collecting data of a plurality of measured variables pertinent to the plant-based ecosystem; normalizing the data; organizing the data in a tensor to enable facilitation of an analysis of the data, by unit of time and in multiple layers; storing the data; using the data in at least one ecosystem model; and storing the output of the at least one ecosystem model.

In a preferred embodiment, for any one of a determined unit of time, the tensor comprises corresponding multiple layers.

In a further preferred embodiment, the multiple layers are organized in a nested structure, and comprise at a highest level at least one of the list comprising a parcel-level data submatrix; identified sub-parcels data submatrix, each one of the sub-parcels being a part of the parcel.

In a further preferred embodiment, the nested structure further comprises linked to the parcel-level data submatrix, a parcel-level specific submatrix, which in turn comprises at least one of the list comprising
an abiotic parcel-level observations submatrix;
a biotic and climatic parcel-level observations submatrix;
an external intervention data submatrix;
a parcel metadata submatrix.

In a further preferred embodiment, the nested structure further comprises linked to the identified sub-parcels data submatrix, a sub-parcel-level specific submatrix, which in turn comprises at least one individual sub-parcel submatrix.

In a further preferred embodiment, the nested structure further comprises linked to at least one of the individual sub-parcel submatrix, an individual sub-parcel specific submatrix, which in turn comprises at least one of the list comprising
an abiotic sub-parcel-level observation submatrix;
a biotic sub-parcel-level observations submatrix;
a sub-parcel-level reflectance observations submatrix;
a sub-parcel-level metadata submatrix;
a sub-parcel-level external interventions observations submatrix;
wherein the number of submatrices comprised in the individual sub-parcel specific submatrix is determined by the number of the plurality of variables for which data are measured.

In a further preferred embodiment, the method further comprising a processing of the data collected and further data gathered, based on an ecosystem model, and output desired ecosystem output parameters.

In a further preferred embodiment, the parcel or sub-parcel data are displayed graphically in a combined way that pivots a stack of juxtaposed graphs, each representing parcel or sub-parcel data, about a center so as to create a circle; the degrees of the circle and corresponding concentric circles of various data types to be represented by one of the list comprising
the time unit;
abiotic observation;
biotic observation;
external intervention;
reflectance.

In a second aspect, the invention provides an apparatus for creating an agricultural plant-based ecosystem for at least a parcel of land and implementing the method according to the first aspect. The apparatus comprises a computational device; a distributed computing infrastructure; a data storage device; data collection means configured to make a collection of data of a plurality of measured variables pertinent to the plant-based ecosystem. The computational device is configured to gather further data from an intended plurality of data sources comprising at least one of the list comprising a satellite imaging system, an airborne imaging system, a terrestrial sensor network. The distributed computing infrastructure is configured to connect the computational device to at least the data storage device. The computation device is further configured to process the data collected and the further data gathered, based on an ecosystem model, and output desired ecosystem output parameters.

In a further preferred embodiment, the apparatus comprises a circular representation of graphical data collected according to the first aspect, such that one variable is rotated and the other variables form concentric circles leading out from the center and the values of the rotated variable form radii of the circle.

### BRIEF DESCRIPTION OF DRAWINGS

The accompanying drawings illustrate the various embodiments of systems, methods, and other aspects of the invention. Any person with ordinary skills in the art will appreciate that the illustrated element boundaries (e.g., boxes, groups of boxes, or other shapes) in the figures represent one example only of the embodiments and the boundaries. In some examples, one element may be designed as multiple elements, or multiple elements may be designed as one element. In some other examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a block diagram depicting data sources and information flow;

FIG. 2 illustrates a conceptual diagram showing a relationship among observed variables and ecosystem (including plant) variables;

FIG. 3 illustrates a methodological process;

FIG. 4 illustrates an example of a circular representation of the pertinent data for a given land parcel (in this case, a farm) during a given time period (in this case, a year); it combines a schematic manifesting the different data types (top) and real data (bottom);

FIG. 5 illustrates a conceptual diagram of nested layers of data in a matrix organisation; and

FIG. 6 illustrates the mapping of matrix data to land sub-parcels.

### DETAILED DESCRIPTION OF PREFERRED EMBODIMENTS OF THE INVENTION

By taking a systemic approach, the present invention facilitates the consideration of significantly more variables pertinent to plant-based ecosystems for each specific land parcel. Additionally, because the present invention organises this data in a time-based manner, natural ecosystem cycles such as the plants' growth and development cycles, the seasonal cycles, among others are more readily taken into account. The carefully thought out organisation of the data delineated below enables the consideration of interactions and interrelationships among the variables in the creation of ecosystem models such as crop models. To this end, the consideration of interactions and interrelationships among variables allows for the creation of land sub-parcels based on characteristics that more accurately and precisely reflect what is happening on the land in question and enable sub-parcel specific ecosystem models.

In contrast to prior art disclosures, the invention as described herein is customizable to many artificial intelligence algorithms, including the algorithm described in patent publication U.S. Pat. No. 6,058,351, which proposes Kohonen neural networks.

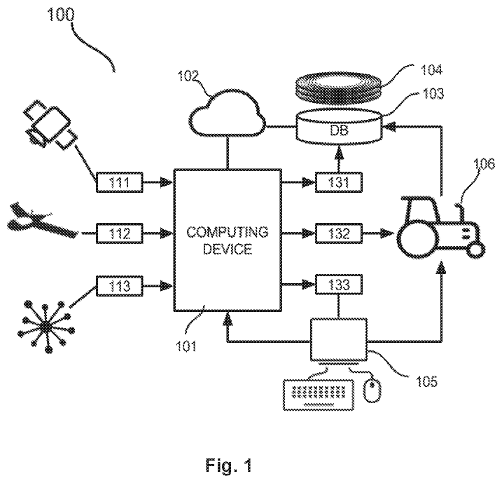

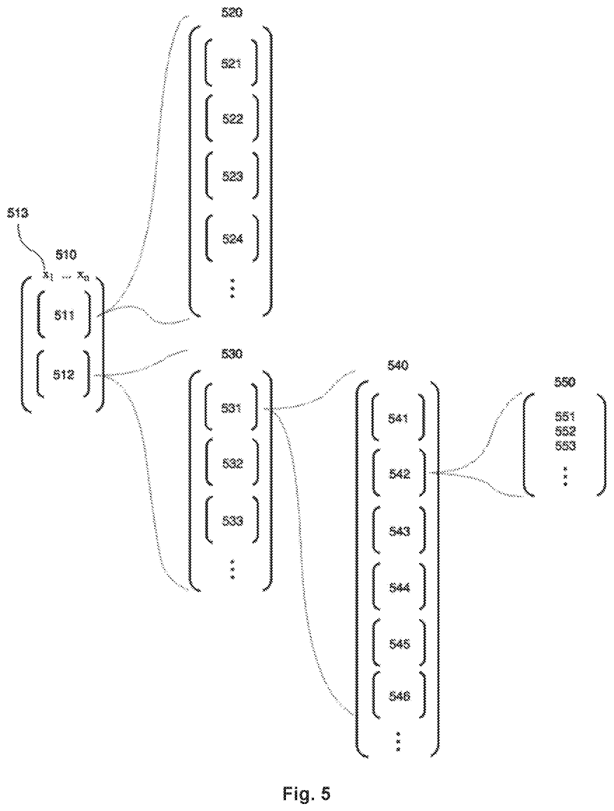

According to the embodiments illustrated herein, there may be an ecosystem and agricultural data management system 100 as shown in FIG. 1, comprising at least a computational device 101, a distributed computing infrastructure—also referred as computing cloud 102—, a data storage device 103, and a collection of systematically organised ecosystem data 104. Furthermore, the computational device 101 may collect a plurality of sets of data from a plurality of data sources, taken from a list comprising, for example, a satellite imaging system 111, an airborne imaging system 112, and a terrestrial sensor network 113. Examples of the collected data may include a plurality of data types as illustrated in FIG. 5, relevant to the ecosystem and agrotechnical operations including, but not limited to, climatic and environmental parameters such as air and soil temperature, sun radiation, humidity, precipitation, soil moisture and wind speed; soil parameters such as soil texture, pH, CEC, salinity, macronutrient content, micronutrient content and hydraulic conductivity; as well as plant parameters such as leaf area index, light use efficiency, crop volume, crop height, plant density, stomata conductance, relative water content, dry matter, respiration rate, nitrogen content, photosynthetic constant and growth stage.

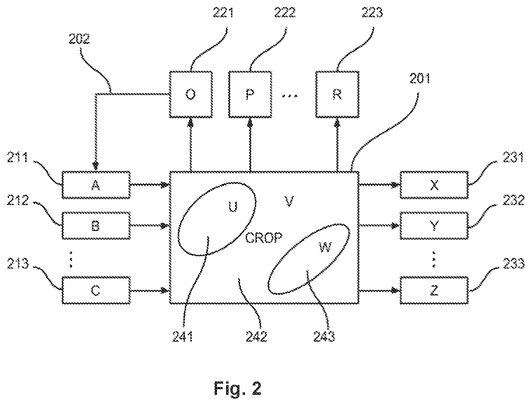

Subsequently, and returning to FIG. 1, the computing device 101 is capable of processing the input data 111-113 and 211-213 (these references are illustrated in FIG. 2) by utilizing the ecosystem models such as crop models (not shown in the figures) retrieved from the data storage device 103 in order to produce the desired ecosystem output parameters 131-133 and 231-233 (again these references are illustrated in FIG. 2), which may include, but are not limited to, the plant volume, the plant height, the available macronutrient content, the plant (crop) yield (not shown in the figures). Data output by the system 131-133 may be used in various ways: to inform the existing ecosystem models 131; to instruct humans, human-operated machinery, and autonomous machinery on precise interventions such as spatially-customised application of agrichemicals 132, and to develop new ecosystem models and modify existing ecosystem models 133. A human interface 105 that may take several forms enables humans to work with the ecosystem models, the output of the models, the data, and algorithms used to create the models.

FIG. 2 illustrates one relationship between the different types of variables discussed herein for a given parcel of land 201. The items 211-213 represent ecosystem characteristics such as abiotic variables, biotic variables, plant traits, etc. Items 221-223 represent observed measurements such as reflectance data, chemical samples, on-land scouting samples, etc. Item 202 is an arrow that shows that the observed measurements feed into the data that describe the ecosystem characteristics by sub-parcel area 241-243. Outputs of the ecosystem—such as biomass, yield, etc.—are depicted by the items 231-233. These outputs become inputs 221-213) in subsequent time periods.

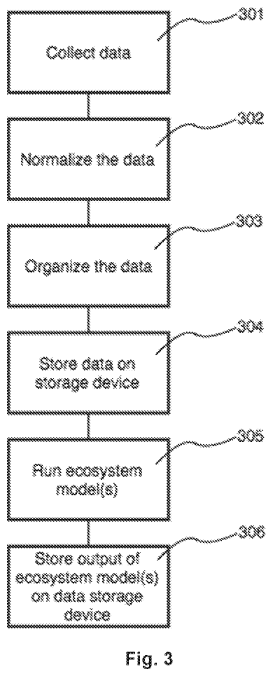

FIG. 3 illustrates a possible process according to the invention. A first step is to collect the data 301, followed by a normalizing 302, then an organizing 303, and an storing of the data 304 on the data storage device 103 (not shown in FIG. 3). Optionally, these data can be used with ecosystem models 305 and, if so, the resulting output stored on the storage device 306.

One element of the preferred embodiment is the organisation of data (measurements) of all variables pertinent to plant-based ecosystems in a manner that facilitates analysis of the data. Referring now to FIG. 5, as new measurement techniques and/or new variables are discovered that are pertinent to plant-based ecosystems, they can be included. The tensor (including vectors and matrices and discussed as matrices herein) structure organises the variables and data in two key ways: 1) by unit of time, and 2) in multiple layers. One dimension of the matrix (envisioned to be the columns) corresponds to the unit of time at which the measurements are taken 513, for example the days of the year or the hours of a day. FIG. 5 illustrates the nesting principle of matrix representation. At its highest level, the matrix 510 comprises two parts or submatrices: parcel-level data 511 and the identified sub-parcels 512, which may be one or more than one in number. Abiotic parcel-level observations 521, data about external intervention—including human interventions executed by automated machines or manually—522, parcel metadata 523, biotic parcel-level observations 524, and other types of variables determined to be pertinent are stored in the parcel-level submatrix 520. Sub-parcel-specific data are grouped by individual sub-parcels 531-533, in a sub-parcel-level submatrix 530. If only one sub-parcel exists, the parcel and sub-parcel are identical pieces of land. The sub-parcel-level submatrix 530 contains its own submatrices: each sub-parcel's submatrix 540 comprises parts, which may be any one from the following list comprising at least: abiotic sub-parcel-level observations 541, biotic sub-parcel-level observations 542, sub-parcel-level reflectance observations 543, sub-parcel-level metadata 544, 545 external intervention at the sub-plot level, and 546 ecosystem model(s) output, along with any other data types determined to be pertinent to plant-based ecosystems. The number of rows in submatrices 541-544 (also 550) is determined by the type of variables for which data are measured. For example, in a submatrix of sub-parcel-level reflectance observations 550, it is envisioned that references 551-553, etc. each record the reflectance values at wavelengths captured by the sensor(s) used to acquire the data 111-112 (from FIG. 1) and that the wavelengths increase from 551. As another example, daily temperature data may be organized in a combination of irreducible units and statistics: maximum temperature of the day, minimum temperature of the day, and average temperature for the day 551, 552, etc. Each variable in the matrix structure of FIG. 5 has data organized in a way that makes sense for the particular measurements. Any particular plant-based ecosystem may have some but not others of these variables and types of variables, or other variables pertinent to land-based ecosystems. Furthermore, any particular plant-based ecosystem may have many or one sub-parcels, in the latter case, where the parcel and the one sub-parcel are identical, the variable data can be stored at either the parcel level or sub-parcel level nested layers.

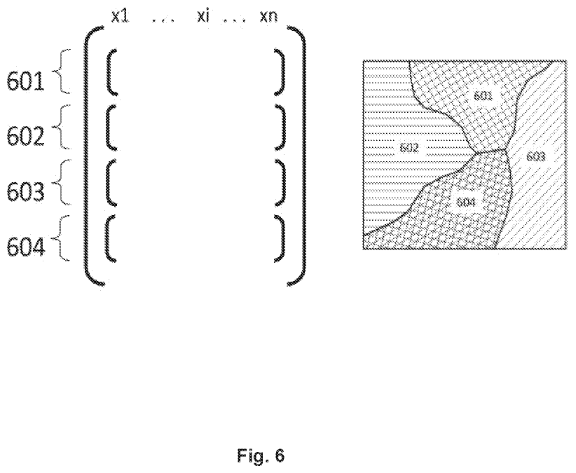

FIG. 6 depicts an example of a sub-parcel-level submatrix containing data of four individual sub-parcels 601-604 (data clusters) (left side of FIG. 600), corresponding to four sub-parcels in a land parcel 601-604 (right side of FIG. 600).

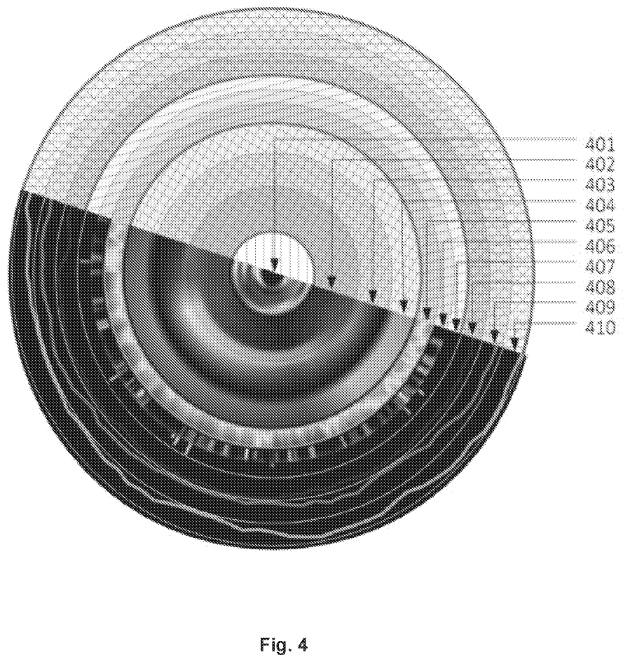

The preferred embodiment of the circular visualisation of the juxtaposed and organized data types rotates the matrix about the column headings (envisioned to be the unit of time such as days or hours, but could be one of the other variables). The first unit of time in the time series is envisioned to be represented at the 12:00 position, if the circle were a clock, and the rotation is envisioned to be clockwise though other orientations are possible. To depict time series data over more than one such time segments, this can be arranged as a spiral that extends in levels such that, for example, when the unit of time is days of the year and the first date is the 1^{st} Jan. year1, then the last date of that level of the spiral is 31^{st} Dec. year1 and the first date of the next level of the spiral is 1^{st} Jan. year2. Therefore, 31^{st} Dec. year1 is contiguous with 1^{st} Jan. year2. FIG. 4 depicts an example of a one-level time period of interest and is split into schematic (top) and an example (bottom). The top part of FIG. 4 shows the diagrammatic representation of the data layers (rings of the circle). The bottom part of the figure displays representative data from a particular farm field in a particular annual time frame with a particular crop (as an example). The data in the rings of the circle are portrayed in different formats according to the nature of the data they contain as described above and illustrated by FIG. 5. A center of the circle 401 holds the metadata represented in a machine readable format such as a QR code, or other means to identify the land parcel or sub-parcel. Rings 402-404 are envisioned to be the reflectance data for the given land parcel or sub-parcels. In situations where the land parcel is separated into sub-parcels, each parcel or sub-parcel has its own representation of the reflectance data (rings 402-404). It is envisioned that the abiotic variables appear in the next rings: ring 405 may be the temperature data or another variable. One embodiment is to display temperature data as the minimum and maximum temperature per unit of time in the time period (e.g., per day in an annual time period). Ring 406 may be the cloud cover and precipitation data. Ring 407 may depict data about the external interventions into the ecosystem such as human-enacted interventions like agricultural operations (e.g. planting, spraying, fertilising, harvesting). Each of rings 408-410 is envisioned to depict data of a different biotic variable—such as the density of an observed infestation (e.g., weeds, pests, diseases, etc.) or plant trait (e.g. plant height, etc.), and so on. As many rings as useful can be added, one ring per variable and they can be arranged in different orders.

### CITATION LIST

Drysdale, G., Metternicht, G., 2003. Remote sensing for site-specific crop management: evaluating the potential of digital multi-spectral imagery for monitoring crop variability and weeds within paddocks. International Farm Management Congress, 2003.

Fraisse, C., Su, H., Harroun, P. J., Lindgren, T. A., 2008. Method for prescribing site-specific fertilizer application in agricultural fields. 7343867.

Hauwiller, J. J., Jin, Y., 2001. System and method for creating agricultural decision and application maps for automated agricultural machines. 6,236,907.

Hernandez, S., 2016. Real-time interactive monitoring system for precision agriculture. 2016191893.

Lemons, K. R., 2008. Device and method for visualizing musical rhythmic structures. 20080245212.

Mathur, A., Barsamian, P. M., Garrison, D. P., Mendez, J. C., Mullan, P., 2016. Precision agriculture system. 2917515.

Pellenc, R., Bourely, A., 2002. Process for using localized agriculture data to optimize the cultivation of perennial plants. 6,336,066.

Precision Agriculture Laboratory, University of Sydney (2016) What is Precision Agriculture? [online]: http://sydney.edu.au/agriculture/pal/about/what_is_precision_agriculture.s html, accessed 23/01/207.

Russell, J. K., Nichols, A. F., Lange, A. F., 2003. Methods and apparatus for precision agriculture operations utilizing real time kinematic global positioning system systems. 6,554,299.

Whelan, B. M., McBratney, A. B., 2000. The ‘Null Hypothesis’ of precision agriculture management. Agriculture, Vol 2, page 265, doi:10.1023/A:1011838806489.

1. A method for creating a plant-based ecosystem for at least a parcel of land, the method comprising collecting data of a plurality of measured variables pertinent to the plant-based ecosystem;
normalizing the collected data;
organizing the data in a tensor to enable facilitation of an analysis of the data, by unit of time and in multiple layers;
storing the data;
using the data in an ecosystem model; and
storing the output of the ecosystem model.

2. The method of claim 1, wherein for a determined unit of time, the tensor comprises corresponding multiple layers.

3. The method of claim 2, wherein the multiple layers are organized in a nested structure, and comprise at a highest level at least one of the list comprising a parcel-level data submatrix; and identified sub-parcels data submatrix, each one of the sub-parcels being a part of the parcel.

4. The method of claim 3, wherein the nested structure further comprises linked to the parcel-level data submatrix, a parcel-level specific submatrix including at least one of the list comprising,
an abiotic parcel-level observations submatrix;
a biotic and climatic parcel-level observations submatrix;
an external intervention data submatrix; and
a parcel metadata submatrix.

5. The method of claim 3, wherein the nested structure further comprises linked to the identified sub-parcels data submatrix, a sub-parcel-level specific submatrix having an individual sub-parcel submatrix.

6. The method of claim 5, wherein the nested structure further comprises linked to the individual sub-parcel submatrix, an individual sub-parcel specific submatrix including one of the list comprising
an abiotic sub-parcel-level observation submatrix;
a biotic sub-parcel-level observations submatrix;
a sub-parcel-level reflectance observations submatrix;
a sub-parcel-level metadata submatrix; and
a sub-parcel-level external interventions observations submatrix; wherein the number of submatrices comprised in the individual sub-parcel specific submatrix is determined by the number of the plurality of variables for which data are measured.

7. The method of claim 1 further comprising the steps of:
processing of the data collected and further data gathered, based on the ecosystem model, and
outputting desired ecosystem output parameters.

8. The method of claim 1, wherein the parcel or sub-parcel data are displayed graphically in a combined way that pivots a stack of juxtaposed graphs, each representing parcel or sub-parcel data, about a center so as to create a circle; the degrees of the circle and corresponding concentric circles of various data types to be represented by one of the list comprising:
the time unit;
an abiotic observation;
a biotic observation;
an external intervention; and
a reflectance.

9. An apparatus for creating an agricultural plant-based ecosystem for at least a parcel of land, comprising
a computational device;
a distributed computing infrastructure;
a data storage device; and
a data collection device configured to make a collection of data of a plurality of measured variables pertinent to the plant-based ecosystem;
wherein the computational device is configured to gather further data from an intended plurality of data sources comprising at least one of the list comprising a satellite imaging system, an airborne imaging system, and a terrestrial sensor network;
wherein the distributed computing infrastructure is configured to connect the computational device to at least the data storage device; and
wherein the computation device is further configured to process the data collected and the further data gathered, based on an ecosystem model, and to output desired ecosystem output parameters.

10. The apparatus of claim 9, comprising
a circular representation of graphical data collected such that one variable is rotated and the other variables form concentric circles leading out from the center and the values of the rotated variable form radii of the circle.
